(19) United States
(12) Patent Application Publication
(10) Pub. No.: US 2022/0343796 A1
(43) Pub. Date: Oct. 27, 2022

(54) PROGRAMMABLE ELECTRONIC CIRCUIT EVALUATION DEVICE FOR EDUCATION

(71) Applicant: LeTourneau University, Longview, TX (US)

(72) Inventor: Glyn Gowing, Longview, TX (US)

(73) Assignee: LeTourneau University, Longview, TX (US)

(21) Appl. No.: 17/726,196

(22) Filed: Apr. 21, 2022

Related U.S. Application Data
(60) Provisional application No. 63/177,996, filed on Apr. 22, 2021.

(51) Int. Cl. G09B 23/18

(52) U.S. Cl. CPC G09B 23/186; G09B 23/185

(57) ABSTRACT

The present invention relates to the instruction and evaluation of electronic circuits. The embodiments disclosed include a circuit instruction device comprised of a at least one control unit, an input/output device, and a bread board with a plurality of sensors. The components are configured to allow the device to read a file that will instruct the user as to the electronic circuit that is to be built and evaluate the performance of the circuit. The device is capable of providing complex digital and analog inputs over time as well as record outputs from the user's circuits over time to correlate the outputs to the inputs provided by the device. This device can be updated with new lessons/courses by way of an SD card and; thereby, is programmable. The device can be used in on-site residential educational environments as well as in remote educational environments.

### CROSS-REFERENCE TO RELATED APPLICATIONS

The present application claims priority to, and benefit of U.S. Provisional Application No. 63/177,996, which was filed on Apr. 22, 2021, and is incorporated herein by reference in its entirety.

### FIELD OF THE INVENTION

The present invention relates generally to the field of electronic circuit building and testing. More specifically, the present invention relates to devices and methods to instruct and assess student learning in the construction and testing of electronic circuits. The present invention can be used in both residential learning and remote learning environments. Accordingly, this disclosure makes specific reference thereto the present invention. Nonetheless, it is to be appreciated that aspects of the present invention are also equally applicable to other like devices and methods.

### BACKGROUND OF THE INVENTION

Testing and evaluation of electronic circuits is needed in manufacturing, construction, and servicing of modern devices. The testing and evaluation of electronic circuits is also needed in the training and education of students hoping to work in the electronic industry. Though there are devices available for the purpose of circuit evaluation and testing, these devices are limited with respect to the types of circuits that can be tested, the level of evaluation of the circuit tested, and the reporting of the test results. Many of these devices are designed for specific applications and are not capable of evaluating circuits outside of that application. In addition, the evaluation is often incomplete and does not provide a thorough test of the circuit or information to the instructor with respect to possible errors in the circuit construction.

The challenges in teaching, testing, and evaluation of student circuit construct are compounded for remote instruction. In these situations, the instructor cannot visually or physical inspect or test the students' circuits and is completely reliant on the circuit evaluation device that may be used by the student at the remote location. Given these challenges, many online courses make use of circuit simulators rather than physical circuit construction, denying students the experiential opportunities of constructing actual circuits. For remote learning that is not online, simulators may be used on stand-alone computers with installed software, but the instructor will not be able to access the student constructed circuits or the simulator's evaluation of the student constructed circuit. Given that remote learning is an important component of contemporary education and that it may be the only available learning option for some students who are isolated or in less resourced settings, it is important that there be a device and process that will allow remote learners to build and test circuits in a manner that will provide feedback to the remote learner and meaningful evaluation for the instructor.

Therefore, there exists a long-felt need in the art for a device and a process to instruct and evaluate electronic circuit construction for both residential learners and remote learners. There is a long-felt need in the art for a device and a process that allows for a wide range of circuit types to be constructed and evaluated and provides both the student and the instructor feedback on the performance of the constructed circuit. There is also a long-felt need for a circuit instruction system that provides students with hands-on experience in circuit construction and analysis.

The invention disclosed herein meets the long-felt needs. It allows students hands-on experience in circuit construction and evaluation. It allows instructors to evaluate student constructed circuits. In addition, it can be used by residential learners or by remote learners, regardless of whether the learners have internet access.

### SUMMARY OF THE INVENTION

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

In one embodiment of the present invention, a circuit instruction device is comprised of at least one control unit, an input device, an output device, an electronic bread board, a memory device, and a plurality of sensors. The control unit is configured to read a circuit instruction file from the memory device, the input device allows a user to select a circuit instruction file, the bread board allows for the construction of the circuit specified in the circuit instruction file, and sensors connecting the bread board to the control unit allow the circuit to be evaluated. The control unit is able to write the results of the circuit evaluation to the output device to be displayed for the user and to the memory device.

In another embodiment of the present invention, a circuit instruction system in herein disclosed. The circuit instruction system includes all the components of the circuit instruction device and is further comprised of two computers. A first computer is used by an instructor to create and send an instruction file containing instructions to a student with respect to building an electronic circuit. The instructor can then send the file to a student via the internet or transfer the file to a mobile memory device that can be delivered to the student. A second computer is used by a student to receive the instruction file either by email or by hand delivery. The second computer is connected to the circuit instruction device of the aforementioned embodiment; thereby, allowing the control unit of the circuit instruction device to access the circuit instruction file. After the student has completed the activity as instructed by the circuit instruction file, the system allows the circuit to be tested. The sensors incorporated into the bread board allow for the measurements of voltage, current, and resistance at every point in the circuit. The control unit analyzes these measurements and compares them to accepted values. If a measurement is outside the range of the accepted values the control unit offers suggestions to the student that may allow the student to correct the circuit. Results of the circuit analysis are stored in a file on the second computer. The student may then send the stored analysis file to the instructor via email or transfer the file to a mobile memory storage device that can be delivered to the instructor.

In yet another embodiment of the invention, a process for the instruction of and assessment of electronic circuits is disclosed. The process is comprised of an instructor writing instructions for building an electronic circuity, transmission via internet or delivery of the instructions to a student, the student building and assessing the circuit, the student recording the assessment of the circuit to a file, and the student transmitting the file via the internet or delivering the file on a mobile memory device to the instructor.

Variations and modifications of these embodiments may include the control unit further comprising a drive to read prepared files stored in a variety of media formats. The drive may be an SD drive or a USB drive. An alternative is to have an internal memory with the device connected directly to the internet.

### BRIEF DESCRIPTION OF THE SEVERAL VIEWS OF THE DRAWINGS

The description refers to provided drawings in which similar reference characters refer to similar parts throughout the different views, and in which:

FIG. 1 illustrates a schematic view of the circuit instruction device showing the operation of the device under conditions when the student does not have a computer in accordance with the disclosed architecture;

FIG. 2 illustrates a schematic view of the circuit instruction device showing the operation of the device under conditions when the student does have a computer, but the computer is not connected to the circuit instruction device in accordance with the disclosed architecture;

FIG. 3 illustrates a schematic view of the circuit instruction device showing the operation of the device under conditions when the student does have a computer and the computer is connected to the circuit instruction device in accordance with the disclosed architecture; and,

FIG. 4 illustrates the steps in the process for constructing and evaluating electronic circuits in accordance with the disclosed architecture.

### DETAILED DESCRIPTION OF THE INVENTION

The invention allows instruction and assessment of circuits built by students. It is programmable to allow for multiple types of instructions and assessments. The invention can be networked or run as a stand-alone unit. The invention is composed of a computer used for programming, sending, and receiving files; a control unit for reading and writing files; a bread board for building circuits; and a plurality of sensors used to evaluate measures related to circuit performance including, voltage, amperage, and ohmage to measure electromotive force, current, and resistance.

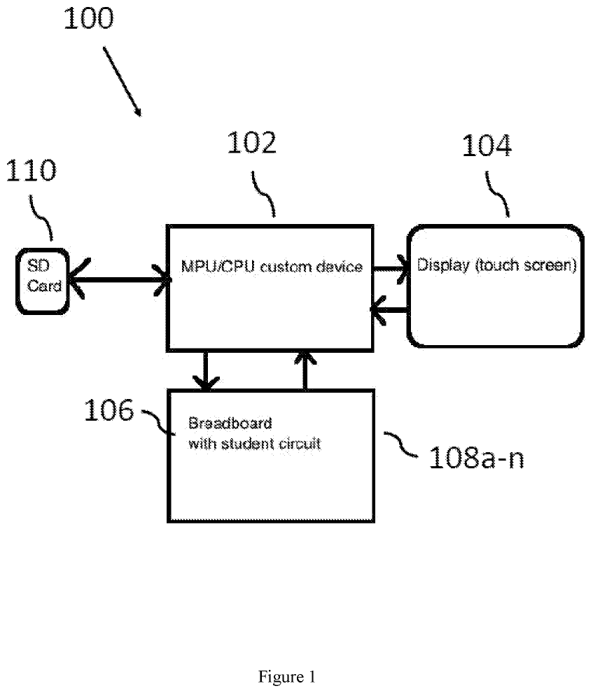

One embodiment of the programmable electronic circuit system is seen in FIG. 1, the circuit instruction device, 100, is comprised of a control unit 102, an input device and output device 104, an electronic bread board 106 that incorporates a plurality of sensors 108a-n. In this embodiment a circuit instruction file is stored on an SD card 110. The input/output display 104 allows a user to select one of a plurality of circuit instruction files on the SD card 110. The control unit 102 is configured to read the circuit instruction file and display the instructions found in the file on the input/output device 104. A student user builds the instructed circuit on the bread board 106. The circuit is tested using the plurality of sensors 108a-n. There is a sensor 108a-n at every junction on the bread board 106. The sensors 108a-n are connected to the control unit 102. The control unit 102 is configured to receive signals from the sensors 108a-n and compare the signal values to the correct values as read from the circuit instruction file.

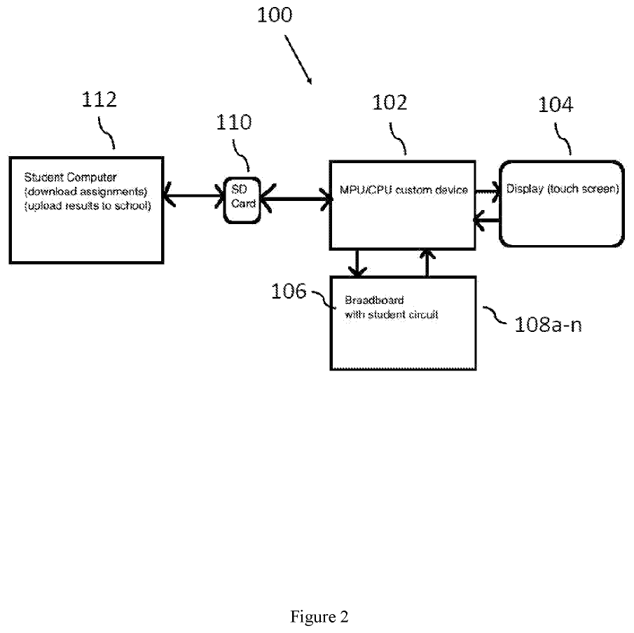

Another embodiment of the invention can be seen in FIG. 2. In this embodiment of the circuit instruction device 100 an SD card 110 is used as a storage media to transfer the files from the student computer 112 to the control unit 102. The use of an SD card 110 as a storage device should not be construed so as to restrict the storage device to an SD card. Any media storage device would function for this purpose. In this embodiment the SD card 110 also transfers the results file from the control unit 102 to the student computer 112 from which the file can be sent to the instructor over the internet. If the student computer 112 is not connected with the internet, the original storage medium may be transported to the instructor, or the file can be saved from the student computer 112 to another storage media which can then be transported to the instructor.

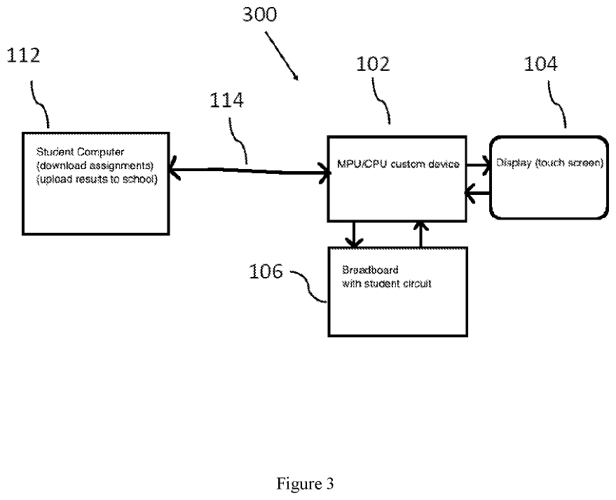

In FIG. 3 yet another embodiment of the present invention is illustrated, the circuit instruction system 300. In this embodiment of the invention, the circuit instruction device 100 is incorporated into a networked computer system. The computer system consists of an instructor's computer, not shown, and a student's computer 112. The instructor is able to send circuit construction files to the student through the internet. The student can download the instruction files to the student computer 112 or directly to the circuit instruction system 100 if it comprises an internal memory device. The student computer 112 is in communication with the control unit 102 through the communication cable 114. The control unit 102 reads the instruction files and writes result files directly to the student computer 112 or reads the files from the internal memory of the circuit instruction device 100 and writes result files to the same. The student can select instructions files through the input/output device 104 and also display the instruction files read by the control unit 102 on the input/output device 104.

The student will construct the circuit, on the breadboard 106, as instructed from the instruction file displayed on the display 104. The control unit 102 is configured to provide power to the breadboard 106 and able to receive and measure power output from the bread board 106 from the plurality of sensors 108a-n not shown. The sensors 108a-n are able to measure voltages at any point in the circuit such that the control unit 102 can monitor and record the voltage, amperage, and ohmage, at any and all points of the circuit in real time. There exists a plurality of sensors 108a-n on the breadboard 106 each of which can be connected to individual ports on the control unit 102. These measures can be recorded by the control unit 102 and written to file on the student computer 112 and displayed on the input/output device 104. The control unit 102, based on the sensor 108a-n signals from the breadboard 106, is configured to provide instructional feedback to the user on the input/output device 104 allowing the user to make corrections to the circuit.

After the student has built a circuit and possibly corrected the circuit as directed from the feedback provided from the control unit 102 on the input/output device 104, the student can save results to an internal memory device of the circuit instruction device 100, or to an SD card 110 (if so equipped) or to the student computer 112. The result files can be transmitted to the instructor from the student computer 112 if the computer is connected to the internet. If the computer is not connected to the internet, the result file can be stored on an appropriate mobile memory device and transported to the instructor.

Not shown in FIGS. 1-3 is the instructor's computer. Software on the instructor's computer allows the instructor to create circuit instruction files and to assess the results files obtained from students. The results files may be obtained from students through the internet or by delivery of the result files on a mobile memory device.

The control unit 102 can be any combination of components that allow a user to select a circuit construction file, send information to the output device 104, receive and analyze signals from the sensors 108a-n and perform all other functions of the invention. The control unit 102 may be comprised of one or more microprocessors, raspberry pi's, digital signal processors, application specific integrated circuits, and field programmable gate arrays.

Also shown in FIGS. 1-3 is an integrated input and output device 104. In the three embodiments shows in FIGS. 1-3 the input/output device 104 is a touchscreen and functions as both the input and the output device. However, variations of these embodiments may incorporate separate input and output devices including keyboards and monitors. The invention 100, 300 may also comprise Wi-Fi and Bluetooth networking capabilities that would allow a smart phone device to act as an input/output device.

The bread board 106 may further comprise a solderless bread board. The type of bread board should not limit the invention. Any bread board that can be used to connect with the inputs and outputs and sensors incorporated into the microprocessor fall within the scope of the invention.

The memory device 110 may be any memory device that allows for storage and retrieval of digital files. In FIGS. 1-3 the memory device shown is an external memory device. The external memory device may be an SD card as shown in FIGS. 1 and 2; however, the memory device could also be a USB drive or flash drive. The memory device may also be built into the invention 100 300 making it an internal memory device.

The sensors measure voltages allowing the control unit 102 to compare measured voltages against expected voltages read from the instructor prepared circuit construction file. The measured and expected voltages can be displayed for student feedback or for instructor evaluation. The measured and expected voltages can be saved to a data file for future access. The number of points from which voltages can be read is determined by the physical design of the device and the software instructions for the particular exercise.

The sensors 108a-n used in the current embodiment are voltage sensors; however, other electronic sensors can also be used. Any electronic sensor that is able to measure voltage, current, or resistance can be used as a sensor 108a-n.

The device may be powered by batteries, a USB power connection, or by a conventional residential AC outlet.

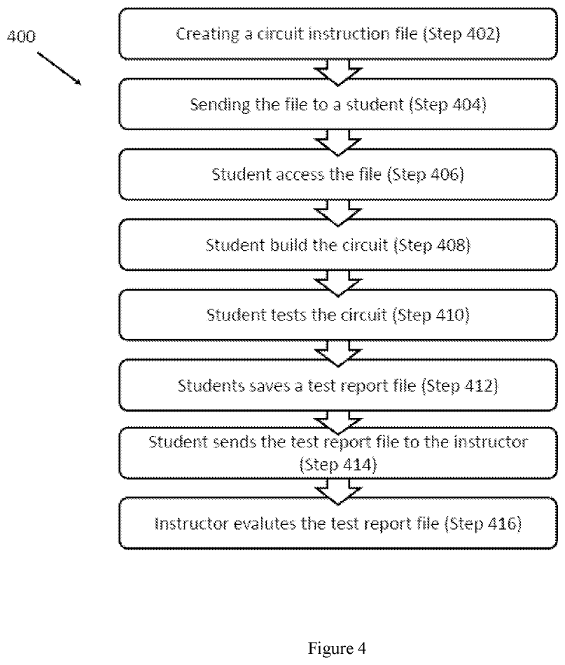

In FIG. 4, yet another embodiment of the present invention is disclosed wherein the embodiment is a process 400 for constructing and evaluating electronic circuits comprised of an instructor creating a circuit instruction file (step 402), sending the circuit instruction file to a student (step 404), the student accessing the file (step 406), building the circuit (step 408), testing the circuit (step 410), saving the test report (step 412), sending the test report file to the instructor (step 414), and the instructor evaluating the test report file (step 416).

The instructor creates the circuit instruction file using a computer having software configured to construct the circuit instruction file. The instructor may send the file to a student via the internet or may store the file on a mobile memory device and deliver the memory device to the student using any appropriate method of delivery.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “circuit instruction device” and “circuit instruction system” are interchangeable and refer to the present invention the programmable electronic circuit evaluation device for education.

Notwithstanding the forgoing, the circuit instruction device 100 and the circuit instruction system 300 of the present invention can be of any suitable size and configuration as is known in the art without affecting the overall concept of the invention, provided that it accomplishes the above stated objectives. One of ordinary skill in the art will appreciate that the circuit instruction device 100 and the circuit instruction system 300 as shown in the FIGS. are for illustrative purposes only, and that many other sizes and shapes of the systems 100 300 are well within the scope of the present disclosure. Although the dimensions of the systems 100 300 are important design parameters for user convenience, the systems 100 300 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of the variations of the disclosed embodiments that may include all or only some of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

We claim:

1. A circuit instruction device comprised of:
at least one control unit;
an input device;
a bread board;
a plurality of sensors electronically connected to the bread board and the at least one control unit;
an output device, and,
a memory device;
the at least one control unit configured to read a circuit instruction file from the memory device;
the input device configured to allow a user to select the circuit instruction file;
the bread board configured to allow a user to construct an electronic circuit;
the at least one control unit configured to produce an assessment of the circuit, send the assessment of the circuit to the output device, and write the assessment of the circuit to the memory device.

2. The circuit instruction device of claim 1 wherein the at least one control unit may be any control unit from the list consisting of microprocessor, raspberry pi, digital signal processor, application specific integrated circuit, and field programmable gate array.

3. The circuit instruction device of claim 1 wherein the input device may be any input device from the list consisting of keyboard, touchpad, and smart phone.

4. The circuit instruction device of claim 1 wherein the sensors are voltage sensors.

5. The circuit instruction device of claim 1 wherein the output device may be any output device from the list consisting of monitor, touchpad, and smart phone.

6. The circuit instruction device of claim 1 wherein the bread board is a solderless bread board.

7. The circuit instruction device of claim 1 wherein the memory device may be any memory device from the list consisting of SD card, USB drive, and flash drive.

8. The circuit instruction device of claim 1 further comprising an internet connection to allow the at least one control unit to access a circuit instruction files from the internet.

9. The circuit instruction device of claim 1 further comprising a wifi and Bluetooth networking capability.

10. A circuit instruction system comprised of:
a first computer configured to allow an instructor to create and send a circuit instruction file;
a second computer configured to allow a student to receive the circuit instruction file;
a circuit instruction device comprised of:
at least one control unit;
an input device;
a bread board;
a plurality of sensors electronically connected to the bread board and the at least one control unit;
an output device, and,
the at least one control unit configured to read a circuit instruction file from the second computer;
the input device configured to allow a user to select the circuit instruction file;
the bread board configured to allow a user to construct an electronic circuit;
the at least one control unit configured to produce an assessment of the circuit, send the assessment of the circuit to the output device, and write the assessment of the circuit to the second computer.

11. The circuit instruction system of claim 10 wherein the at least one control unit may be any control unit from the list consisting of microprocessor, raspberry pi, digital signal processor, application specific integrated circuit, and field programmable gate array.

12. The circuit instruction system of claim 10 wherein the input device may be any input device from the list consisting of keyboard, touchpad, and smart phone.

13. The circuit instruction system of claim 10 wherein the output device may be any output device from the list consisting of monitor, touchpad, and smart phone.

14. The circuit instruction system of claim 10 wherein the circuit instruction device further comprises a memory device wherein the memory device may be any memory device from the list consisting of SD card, USB drive, and flash drive.

15. The circuit instruction system of claim 10 further comprising a wifi and Bluetooth networking capability.

16. A process for constructing and evaluating electronic circuits comprised of:
an instructor creating a circuit instruction file;
sending the circuit instruction file to a student;
the student accessing the circuit instruction file;
the student building a circuit;
the student testing the circuit;
the student saving a test result file;
the student sending the test result file to the instructor: and,
the instructor evaluating the test result file.

17. The process for constructing and evaluating electronic circuits of claim 16 wherein the instructor creates the circuit instruction file on a computer having software configured to create the circuit instruction file.

18. The process for constructing and evaluating electronic circuits of claim 16 wherein the student accesses, builds, and evaluates the circuit on a circuit instruction device comprised of:
at least one control unit;
an input device;
a bread board;
a plurality of sensors electronically connected to the bread board and the at least one control unit;
an output device, and,
a memory device;
the at least one control unit configured to read a circuit instruction file from the memory device;
the input device configured to allow a user to select the circuit instruction file;
the bread board configured to allow a user to construct an electronic circuit;
the at least one control unit configured to produce an assessment of the circuit, send the assessment of the circuit to the output device, and write the assessment of the circuit to the memory device.

19. The process for constructing and evaluating electronic circuits of claim 16 wherein the instructor evaluates a student's circuit test file on a computer having software configured to evaluate the student's circuit test file.

20. The process for constructing and evaluating electronic circuits of claim 16 wherein the instructor and the student send files through the internet or by mailing a mobile memory device containing the file.
